(19) United States
(12) Patent Application Publication
(10) Pub. No.: US 2007/0091383 A1
(43) Pub. Date: Apr. 26, 2007

(54) Synchronization of two ASICs for dual-sided scanning of a document

(75) Inventors: David A. Crutchfield, Georgetown, KY (US); James A. Ward, May's Lick, KY (US); Doyle A. White, Lexington, KY (US); Joseph K. Yackzan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/256,828

(22) Filed: Oct. 24, 2005

(51) Int. Cl. H04N 1/04

(52) U.S. Cl. 358/474; 358/498

(57) ABSTRACT

A method and system for performing dual-sided scanning of an original document in a device having an automatic document feeder uses two application specific circuits (ASICs), each ASIC configured to control an associated scanning element. A first of the two ASICs receives position information about a motor associated with the automatic document feeder, or the document itself, and uses this position information to determine when to read a line of scan data from its associated scanning element. The first ASIC also uses the position information to create a scanning synchronization signal that is sent to the second ASIC. The second ASIC uses the scanning synchronization signal to determine when to read data from its associated scanning element.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING ETC

None.

### BACKGROUND

1. Field of the Invention

The present invention is directed to scanners, copiers and multifunction devices which are capable of scanning both sides of a document in a single pass. It is particularly directed to such devices that employ at least two application specific integrated circuits for processing scanned data from each side of the document.

2. Description of the Related Art

Multifunctional devices such as a printer/scanner/copier, other all-in-one devices, or the like, are commonplace. As is known to those skilled in the art, such devices generally have a scanner bar which either moves relative to an original document, or is stationary as the original document passes by. These devices also have a printing assembly forming an image on a substrate, mechanical devices to feed the substrate, original documents, scanner bar, ink supply and the like.

Some prior art copiers and multifunction devices are configured to scan both sides of a document in a single pass, without flipping over the document. An example of this can be found in U.S. Published Application No. 2004/0252355 to Chen. The device disclosed in this reference has an automatic document feeder and a flatbed scanner. The automated document feeder includes a top image-reading module, a top circuit and a sheet feeding mechanism. The flatbed scanner includes a bottom image-reading module, a bottom motor, a bottom circuit, a bottom memory, a keyboard and a monitor.

When a document is placed in the automatic document feeder and an operator presses the ‘copy’ button on the keyboard, the document is propelled past the two image-reading modules, the bottom image-reading module capturing a first side of the document and the top image-reading module capturing the second side of the document. The analog output from the top image reading module is sent to the top circuit where it is converted into a top digital signal and then sent on to the bottom circuit. The bottom circuit sends this top digital signal on to an image processing device, such as a printer.

The bottom circuit includes a clock generator for generating a bottom clock signal that controls the bottom image reading module. As seen in the embodiment of FIG. 2 of this reference, the bottom clock signal may be transferred to the automatic document feeder to control the reading operations of the top image-reading module. The bottom circuit of this reference is implemented as an application specific integrated circuit (ASIC).

Such an ASIC may belong to a printed circuit board (PCB) carrying a number of components to control various operations. FIG. 1 shows a layout of a typical PCB 100 of the sort used in a copier, scanner or multifunction device. It is understood that the wiring, bus lines, etc. have been omitted from this figure. The PCB 100 carries a number of components, and some of the more important of these are briefly discussed.

First and foremost, the PCB 100 carries a controller ASIC 102 which provides the majority of the control (both in hardware and firmware) for the multifunctional device. The controller ASIC 102 typically contains mostly digital logic. It is understood that the controller ASIC 102 may be a single chip, as shown in FIG. 1, or may be implemented as a chip set.

The controller ASIC 102 communicates with a number of other components resident on the PCB 100. These include a volatile system memory 104, a non-volatile memory 106, an analog ASIC 108, motor driver circuitry 110, analog front end 112, communication devices 114, sensors 116 and connectors 118. It is understood that there may be one or more of each of these, as needed.

The volatile system memory 104 is used to store and retrieve processor instructions and data. This memory is also used by any custom hardware to store data such as image data. The non-volatile memory 106 (SFLASH, NVRAM, etc.) is used to store the firmware base (compiled microprocessor code plus any extra data needed to run the device) so that on power-up, processor code can be transferred from the slow non-volatile memory 106 to the fast volatile system memory 104. From the fast volatile system memory 104, the processor will execute its code base.

The analog ASIC 108 typically contains the analog circuitry necessary to deliver the appropriate voltage levels to the components on the PCB (e.g. 5V, 3.3V, 1.8V). This ASIC 108 may also contain motor drivers and other analog electronics needed by the device. It is understood that the functional purposes of certain features of the controller ASIC 102 and the analog ASIC 108 may be combined into a single ASIC.

The motor driver circuitry 110, which may be implemented as one or more special ASICs or comprised of discrete components (e.g. transistors, resistors, etc), converts digital control signals to speed and position control signals for the motors of the multifunction device.

The analog front end 112 (AFE) is used to convert the analog signals from the scanner bar to digital signals for use in the controller ASIC. This chip provides image data from a scanner to the controller ASIC.

The miscellaneous communication devices 114 may provide a means of communication to and from other devices such as a personal computer (PC), card readers, digital cameras, etc. These devices may simply be connectors or may contain discrete components such as ASICs and other components.

The sensors 116 may be present to detect things such as open covers and the like. The connectors 118 are present to connect the PCB 100 to other pieces of the device such as the motors, op-panel, scanner bar, printheads, etc.

Other components such as resistors, capacitors, inductors, voltage regulators, etc. are typically provided on the PCB 100 and serve a variety of functions to complete the electronics for the PCB as is known to one of skill in the art.

The controller ASIC 102 for a multifunction device is charged with a number of tasks. Included among these are image processing operations, such as for rendering an image line by line. To increase performance for such memory-intensive tasks, the ASIC 102 may be provided with a sizable onboard static random access memory (SRAM) and may also be provided with a cache memory for quick access to instructions and/or data that otherwise may reside in volatile memory 104.

### SUMMARY OF THE INVENTION

In one aspect, the present invention is directed to a method of scanning both sides of a document, in a single pass, in a scanner, copier or multifunction device having an automatic document feeder, a motor associated with the automatic document feeder, a first integrated circuit (IC) configured to control a first scanning element for scanning a first side of the document, and a second IC configured to control a second scanning element for scanning a second side of the document. The inventive method comprises receiving, at the first IC, information reflective of movement or position of at least one of the motor and the document; creating, by the first IC, a synchronization signal in response to said information, and supplying the synchronization signal to the second IC; and obtaining, at the second IC, second scan data from the second scanning element, in response to said synchronization signal.

In another aspect, the present invention is directed to a scanner, copier or multifunction device configured to simultaneously scan both sides of a document in a single pass. The inventive scanner, copier or multifunction device comprises an automatic document feeder for feeding a document; a first integrated circuit (IC) configured to: communicate with a motor associated with the automatic document feeder; communicate with a first scanning element arranged to scan a first side of the document; and receive information reflective of movement or position of at least one of said motor and said document. The inventive scanner, copier or multifunction device further comprises a second IC configured to communicate with a second scanning element arranged to scan a second side of the document. In the inventive scanner, copier or multifunction device, the first IC creates a synchronization signal in response to said information and supplies said synchronization signal to the second IC, and the second IC receives scan data from the second scanning element, in response to said synchronization signal.

In still another aspect, the present invention is directed to an improvement in a method of operating a multifunction device configured to support a dual-sided copying operation in which both sides of an original document are copied in a single pass using an automatic document feeder having a motor associated therewith, the multifunction device having a first application specific integrated circuit (ASIC) configured to obtain first scan data from a first side of said document using a first scanning element and prepare said first scan data for printing. The improved method comprises providing a second ASIC configured to process second scan data from a second side of said document using a second scanning element; creating, by said first ASIC, a synchronization signal based on information reflective of movement or position of at least one of the motor and the original document, and then providing said synchronization signal to the second ASIC; obtaining, at the second ASIC, second scan data from a second scanning element, in response to said synchronization signal; and sending, from the second ASIC to the first ASIC, processed second scan data so that the first ASIC may prepare said processed second scan data for printing. The first and second ICs may be application specific integrated circuits.

In such an improved method, the information may comprise one or more pulses from a position encoder, the synchronization signal comprises a waveform substantially similar to a cleaned up version of the one or more pulses, the method may further comprise forming a first control signal based on at least one of said pulses; obtaining, at the first IC, said first scan data in response to said first control signal, forming a second control signal based on said synchronization signal; and obtaining, at said second IC, said second scan data in response to said second control signal.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows the layout of a PC board of the type used in a multifunction device, such as an all-in-one printer;

FIG. 2 shows a block diagram of a system in accordance with the present invention;

FIG. 3 shows a flow chart explaining the operation of the block diagram of FIG. 2;

FIG. 4 shows a block diagram of a first type of ASIC used in conjunction with the present invention;

FIG. 5 shows a block diagram of a second type of ASIC used in conjunction with the present invention;

FIGS. 6A and 6B show a timing diagram of a first embodiment of a synchronization signal and a resulting second control signal based on using both rising and falling edges of the synchronization signal; and

FIGS. 6C and 6D show a timing diagram of a first embodiment of a synchronization signal and a resulting second control signal based on using only the rising edges of the synchronization signal.

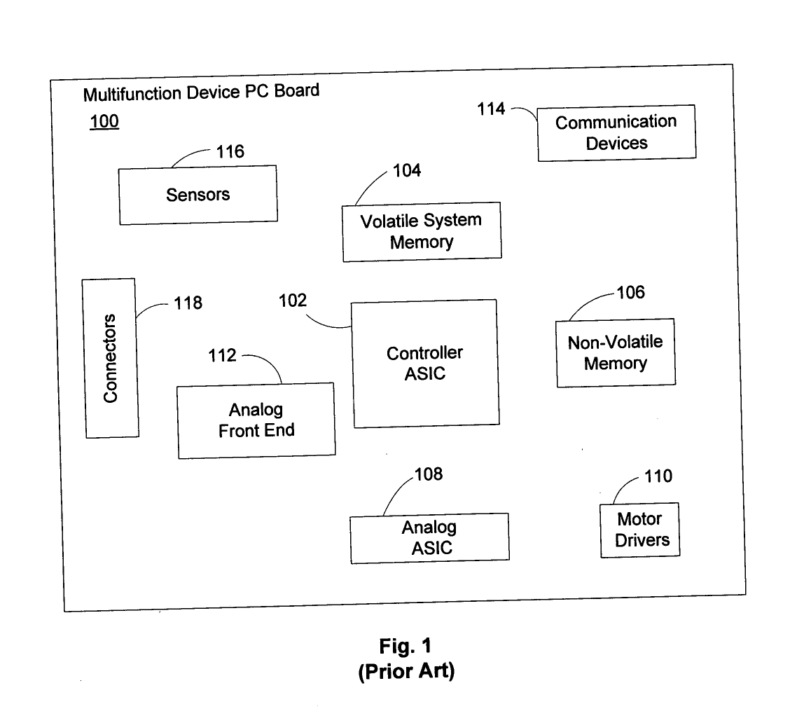

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The term output as used herein encompasses output from any printing device such as color copier, color printers, and so-called color “all-in-one devices” that incorporate multiple functions such as scanning, copying, and printing capabilities in one device. Such printing devices may utilize ink jet, dot matrix, dye sublimation, laser, and any other suitable printer type. The term button as used herein means any component, whether a physical component or graphic user interface icon, that is engaged to initiate input or output.

The contents of aforementioned U.S. Published Application No. 2004/0252355 to Chen are incorporated by reference to the extent necessary to understand the present invention.

The present invention is directed to a device, such a scanner, copier or multifunction device provided with an automatic document feeder, the device being capable of scanning both sides of a document in one pass, without flipping the document. Such a device is provided with two scanning elements—a first, lower scanning element that normally is associated with the body of the device and configured to scan a first side of the document, and a second, upper scanning element that is normally associated with the automatic document feeder and configured to scan a second side of the document.

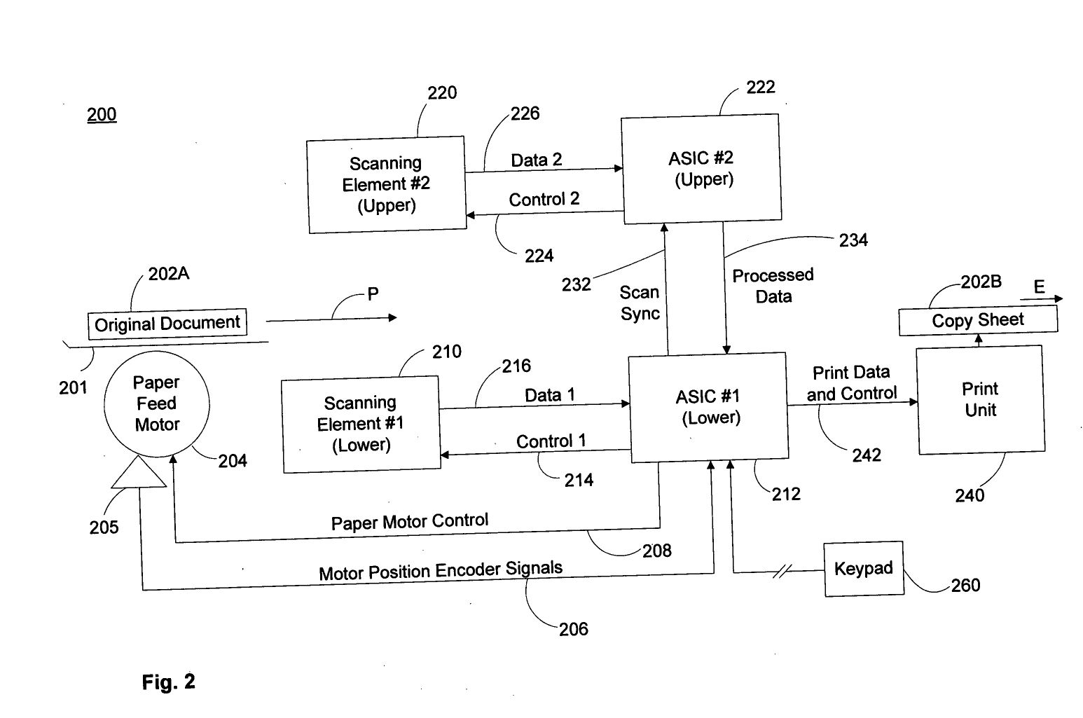

FIG. 2 shows a block-level diagram of an embodiment of the present invention in such a device 200, which may be a multifunction device.

An original document 202A is placed in an automatic document feeder 201. Upon activation of a ‘copy’ or ‘scan’ key on a keypad 260, the original document 202A is propelled by a paper feed motor 204. The motor 204 may be a DC motor, an analog stepper motor, or some other sort of motor suitable for such an application.

The original document 202A is propelled along a path P, which may be curved, and travels past a pair of scanning elements 210, 220 which are spatially offset from one another along the path, to help ensure that the light from one scanning element does not cause spurious signals at the other scanning element. The first scanning element 210 (the “lower” scanning element) is associated with the body of the device and is configured to read a first side of the document, while the second scanning element 220 (the “upper” scanning element) is associated with the automatic document feeder and is configured to read a second side of the document. Each scanning element 210, 220 comprises one or more rows of detectors conventionally used for scanning a line of the document, a plurality of such rows being used for color scanning in a known manner.

A pair of application specific integrated circuits (ASICs) 212, 222 control the scanning elements 210, 220, respectively. Among other inputs, lower ASIC 212 ultimately receives a signal resulting from activation of the keypad 260, perhaps via other devices, connectors and the like. In response to such activation, lower ASIC 212 sends first control signals 214 to the lower scanning element 210 and receives scanned image data 216 from the lower scanning element 210. Similarly, upper ASIC 222 sends second control signals 224 to the upper scanning element 220 and receives scanned image data 226 from the upper scanning element 220. In addition to controlling the scanning elements, the ASICs may also perform other tasks, such as image processing and preparing the image for printing, such as by performing error diffusion, and the like.

Although the second scanning element 220 typically is mounted on a surface of an automatic document feeder, the second ASIC 222 need not be. In fact, the second ASIC 222 and the first ASIC 212 may both be co-located on a common PCB within a lower housing of the device 200, with an electrical connection between the second ASIC 222 in the housing to the second scanning element 220.

Lower ASIC 212 is connected to, and controls, the paper feed motor 204. More particularly, the lower ASIC 212 sends motor control signals 208 to the paper feed motor 204. The nature of these motor control signals 208 will depend on the type of motor 204 that is used, and perhaps also on options selected by an operator such as scanning or printing resolution.

The paper feed motor 204 has an associated position encoder 205 which provides position information 206 to the lower ASIC 212. In one embodiment, the position encoder 205 comprises a wheel with sprockets mounted on the motor 204. As the motor turns, the sprockets interrupt a light beam from an LED or other light source aimed at a light detector. In other embodiments, the position encoder 205 may comprise a series of dark and light stripes affixed to the motor, with a nearby light detector configured to detect transitions from light to dark and vice versa, as the motor turns.

Regardless of how the position encoder is implemented, it typically outputs a series of pulses. These pulses may be reflective of a movement of the motor, or even the document. The frequency with which these pulses are received is therefore indicative of the speed of the motor. And since the motor speed is related to the distance traveled by the original document 202A, one may count the position encoder pulses and translate this into how far the document has advanced. Thus, motor position encoder signals 206 from the position encoder 205 help provide information about movement of the motor, and this information is generally sufficient for the lower ASIC 212 to detect when, and how far, the original document has advanced.

The pulses from the position encoder 205 are noisy and so they are filtered by the first ASIC 212. This results in a signal with unambiguous digital transitions. Information in these “cleaned” pulses may be further processed to create the first control signal 214 for controlling the first scanning element 210. The first control signal 214 causes a read operation from scanning element 210, resulting in a scan line worth of data 216 from the first side of the original document 202A to be provided to the lower ASIC 212. It is noted here that information in the cleaned pulses is also used to create the scanning synchronization signal 232, which is sent to the second ASIC 222 to create a second control signal 224 for controlling the second scanning element 220.

After the lower ASIC 212 completes processing the scan data from the first side of the original document 202A, it sends appropriate print data and control signals 242 to the print unit 240. The print unit 240 then causes the scanned image to be printed onto copy sheet 202B, which is then ejected, as indicated by arrow E.

When the upper ASIC 222 completes processing the scan data from the second side of the original document 202A, it sends the processed scan data 234 to the lower ASIC 212 for similar treatment. The processed scan data 234 may, in part, comprise a compressed version of the scan data 226. Regardless of its nature, the processed scan data 234 is typically sent via a universal serial bus (USB) connection, although other connection protocols may be used.

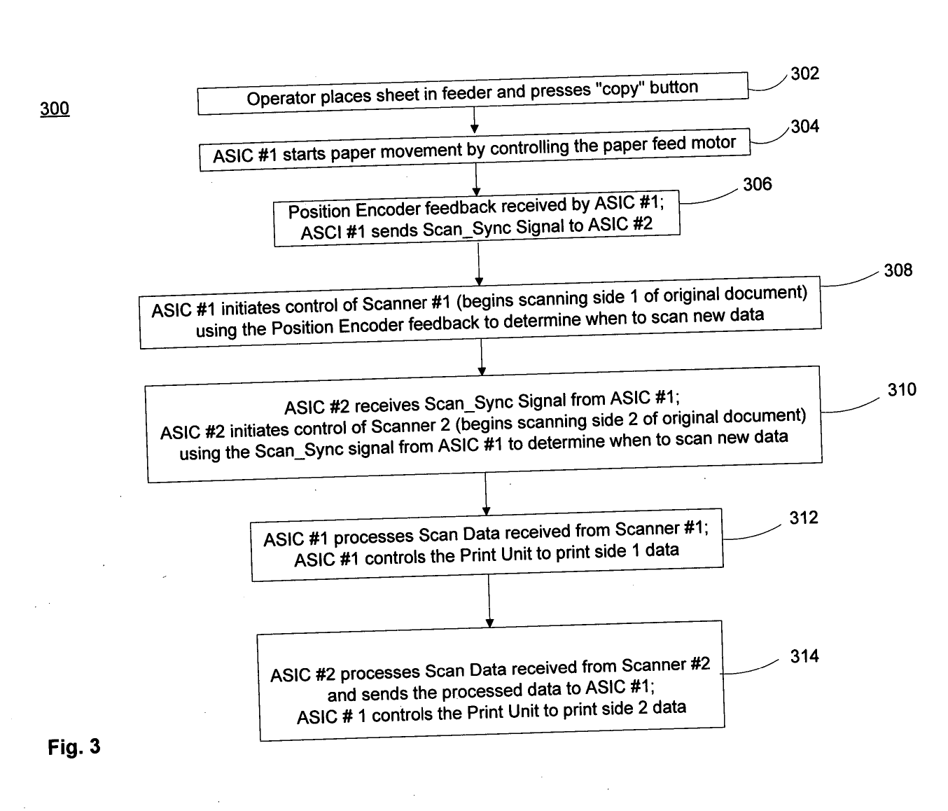

FIG. 3 presents a chart 300 illustrating the principal operations executed in one embodiment of the operation of a device 200 in accordance with the present invention.

In the operation depicted by box 302, an operator places a document in an automatic document feeder of a copier or multifunction device and presses the “copy” button. It is understood that such a feeder may receive multiple pages, each of which is to be copied on both sides.

In the operation depicted by box 304, responsive to the pushing of the ‘copy’ button, the first ASIC 212 starts paper movement by controlling the paper feed motor 204.

In the operation depicted by box 306, the position encoder 205, which is configured to monitor the motor 202A, sends motor position encoder signals 206 comprising position information to the first ASIC 212. It is understood, however, that in some embodiments, the position encoder 205 may provide position information about the original document 202A, such as the latter's forward edge. In such case, the pulses from the position encoder may reflect movement of the document. In response to the position information, the first ASIC 212 creates and sends a scanning synchronization signal 232 to the second ASIC 222.

In the operation depicted by box 308, the first ASIC 212 initiates control of its associated first scanning element 210, which begins scanning the first side of the original document 202A. The position information is used by ASIC 212 to determine when to scan a new line of data as the original document advances.

In the operation depicted by box 310, the second ASIC 222 receives the scanning synchronization signal 232 from the first ASIC 212, and in response thereto, initiates control of its associated second scanning element 220. Scanning element 220 begins scanning the second side of the original document 202A. The scanning synchronization signal 232 is used to govern when the scanning element 220 is to scan a new line of data, as discussed further below.

In the operation depicted by box 312, the first ASIC 212 receives and processes scan data from the first scanning element 210, and sends appropriate signals 242 to the print unit 240 to print lines scanned from the first side of the original document 202A onto the copy sheet 202B.

And, as depicted in the operation represented by box 314, the second ASIC 222 receives and processes scan data from the second scanning element 220, and sends the processed scan data 234 corresponding to lines scanned from the second side of the original document 202A to the first ASIC 212. The first ASIC uses the processed scan data 234 to form appropriate signals 242 that are sent to the print unit 240 to print the second side of the original document 202A onto the copy sheet 202B.

In one embodiment, the processed scan data 234 is stored by the first ASIC 212 in an attached memory until the entire page from the first side of the original document has been printed, and only then is any portion of the second side printed. In other embodiments in which the print unit 240 is capable of simultaneously printing on both sides of the copy sheet 202B, the print data 242 may comprise processed scan data 234 from the second scanning element 220 interleaved with data from the first scanning element 210. In still other embodiments in which the print unit is to print both sides of the original document 202A onto a single side of the copy sheet 202B (perhaps in reduced form), the print data 242 again may comprise processed scan data 234 from the second scanning element 220 interleaved with data from the first scanning element 210. In all these embodiments, however, the second ASIC 222 receives a scanning synchronization signal 232 from the first ASIC 212, returns processed scan data 234 to the first ASIC 212, and only the first ASIC 212 sends print data to the print unit.

It is understood that many of the operations described above may be repeated a number of times during two-sided copying of a single document, and that a number of these may take place simultaneously. Therefore, the arrows between the operations are not intended to represent a steadfast sequence of operations, but rather to convey a candidate sequence. Generally speaking, more or less during the entire time that the document is moving, the position encoder 205 outputs useful position information, the scanning synchronization signal 232 is created, and the scanning elements 210, 220 both continue to scan portions of opposite sides of the original document 202A.

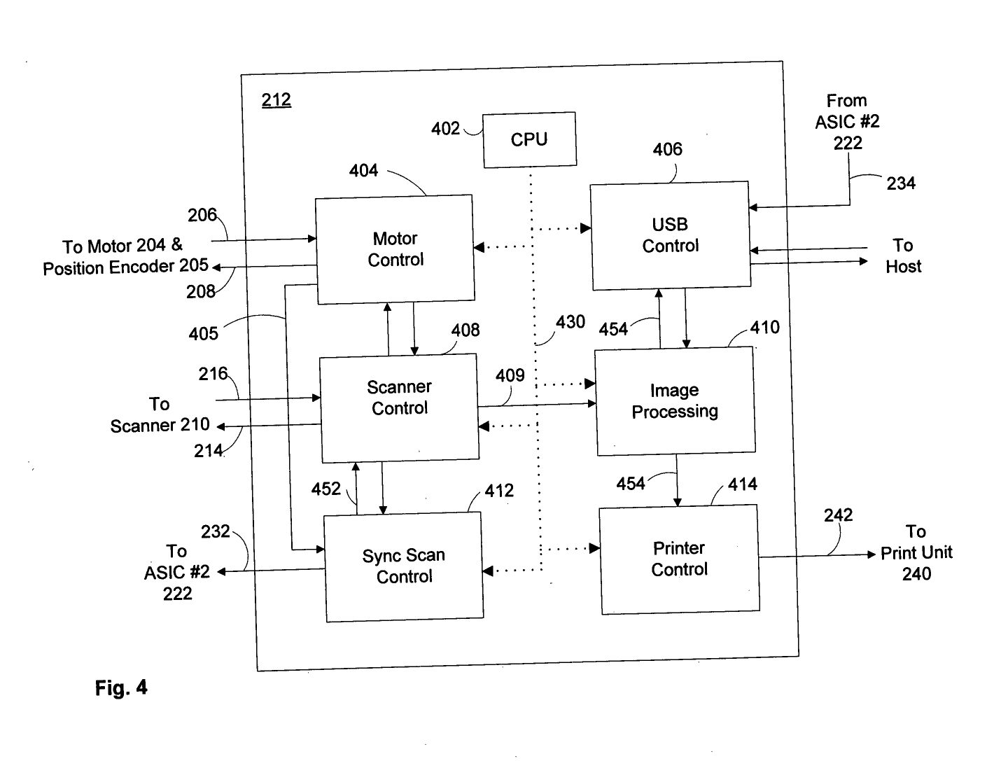

FIG. 4 shows a block diagram of one embodiment of the lower ASIC 212 seen in FIG. 2. The lower ASIC 212 includes a programmable CPU 402 which communicates via an internal bus 430 with various onboard subcomponents, represented as blocks in the figure. Included among these subcomponents of lower ASIC 212 are a motor control block 404, a USB communication control block 406, a scanner control block 408, an image processing block 410, a scanning synchronization signal control block 412 and a printer control block 414. It is understood that the ASIC 212 may have an onboard clock (not shown) which provides a first clock signal for the various subcomponents, along with other circuitry, power connections, and the like. It is further understood that while each of these subcomponents typically comprise circuitry, some, if not all, of their functionality may be implemented in software or firmware.

The motor control block 404 communicates with the position encoder 205 and the motor 204, as described above with respect to signals 206, 208, respectively. The pulses constituting the motor position encoder signals 206 are sent to the scanning synchronization signal control block 412 via connection 405, although the internal bus 430 may be used in some embodiments. In one embodiment, the pulses are first cleaned up or filtered at the motor control block 404 before being sent on to the scanning synchronization signal control block 412. In another embodiment, the pulses are cleaned up at the scanning synchronization signal control block 412. Filters may be used to clean up these pulses to ensure unambiguous binary values.

The scanning synchronization signal control block 412 uses the cleaned up pulses from the position encoder 205 to create the scanning synchronization signal 232 which is sent to the second ASIC 222, where it is used to help determine when a line of data should be read from the second scanning element 220.

The scanning synchronization signal control block 412 also uses the cleaned up pulses from the position encoder to create a first internal scanning signal 452 which is provided to the local scanner control block 408. At the local scanner control block 408, the second internal scanning signal 452, in the form of a first control signal 214, requests the first scanning element 210 to send read data to the ASIC 212. This causes a read operation of the first scanning element 210 which results in a line of scan data from the first side of the original document 202A being sent to the first ASIC 212. It is understood that in some embodiments, the first internal scanning signal 452 and the first control signal 214 are one and the same.

The scan data from the scanning element 210 are then provided via connection 409 to the image processing block 410, although they may be sent via internal bus 430 in other embodiments. It is understood that in one embodiment they may be sent directly to USB control 406 without performing the image processing step. The image processing block 410 performs one or more image preparation or image enhancement operations on the scan data to form modified image data 454. Then, depending on the operating mode selected (‘copy’, ‘scan’, etc.), the modified image data 454 may be sent to the printer control block 414 where it is formatted into a form appropriate for printing on the print unit 240, and/or to the USB control block 406 where it is prepared for transmission to a host, such as a personal computer. It is also understood that the modified image data 454 may be transferred via internal bus 430.

The manner in which the cleaned up pulses from the position encoder 205 are used to create the first internal scanning signal 452, and the scanning synchronization signal 232, is now described.

At the outset, it should be understood that the scanning synchronization signal control block 412 is programmable and so may operate in different modes.

In one embodiment, the cleaned up pulses are used directly as the first internal scanning signal 452. In such case, the scanner control block 408 is triggered to send the first control signal 214 to the first scanning element 210 based on either the rising edge, the falling edge, or both the rising and falling edges of the first internal scanning signal 452. The decision as to which ‘edge-mode’ is used may be determined by programming, firmware or even hardware.

In another embodiment, the scanning synchronization signal control block 412 counts the cleaned up pulses and when a first predetermined number of cleaned up pulses has been received, a single pulse is sent to the scanner control block 408 as the first internal scanning signal 452. Once this first predetermined number is reach, the count is reset to zero and the cleaned up pulses are again counted to send the next single pulse to the scanner control block 408. It is understood that the first predetermined number may be as low as one—i.e., a line of scan data is read after every such pulse. It should also be evident that setting the first predetermined number to a value greater than one results in a reduced spatial sampling of the original document along its travel path, since scan data would not be read as frequently as possible. Regardless of what value is selected for the first predetermined number, the first internal scanning signal 452 is created so long as the motor turns and pulses are received from the position encoder 205.

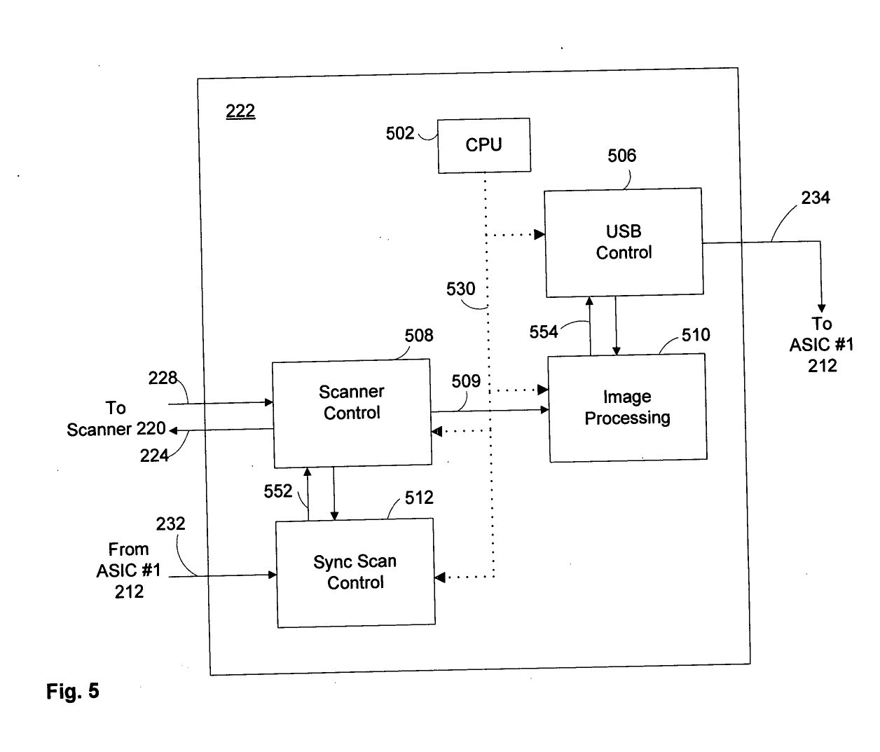

As discussed above, the purpose of the scanning synchronization signal 232 is to tell the second ASIC 222 when to read a line of scan data from the second scanning element 220, and this signal 232 is created by the first ASIC 212 and sent to the scanning synchronization signal control block 512 of the second ASIC 222 as shown in FIG. 5. In one embodiment, the scanning synchronization signal 232 sent by the scanning synchronization signal control block 412 of the first ASIC 212 simply comprises the cleaned up pulses from the position encoder 205. In such case, the synchronization signal comprises a waveform substantially similar to a cleaned up version of one or more of the pulses. In other embodiments, the scanning synchronization signal 232 may comprise a triggering pulse that is output upon receipt of a first predetermined number of pulses from the position encoder.

FIG. 5 shows a block diagram of one embodiment of the upper ASIC 222 seen in FIG. 2. The upper ASIC 222 includes a programmable CPU 502 which communicates via an internal bus 530 with various onboard subcomponents, represented as blocks in the figure. Included among the subcomponents of upper ASIC 222 are an USB communication control block 506, a scanner control block 508, an image processing block 510, and a scanning synchronization signal control block 512. It is again understood that the upper ASIC 222 may have an onboard clock (not shown) which provides a first clock signal for the various subcomponents, along with other circuitry, power connections, and the like. It is again further understood that while each of these subcomponents typically comprise circuitry, some, if not all, of their functionality may be implemented in software or firmware.

The scanning synchronization signal control block 512 of the upper ASIC 222 receives the scanning synchronization signal 232 from the first ASIC 212. In response to this signal 232, the scanning synchronization signal control block 512 creates and sends a second internal scanning signal 552 to the local scanner control block 508, not unlike the case with scanning synchronization signal control block 412.

At the local scanner control block 508, the second internal scanning signal pulse 552, in the form of a second control signal 224, causes the second scanning element 220 to provide a line of scan data to the second ASIC 222. The result of this is that a line of scan data from the second side of the original document 202A is received by the ASIC 222. These data are provided via connection 509 to the image processing block 510, although they may be sent via the internal bus 530 in some embodiments. It is understood that in one embodiment they may be sent directly to USB control 506 without performing the image processing step. The image processing block 510 performs one or more image preparation or image enhancement operations on the scan data to form modified image data 554, which is then sent to the USB control block 506 where it is prepared for transmission back to the first ASIC 212 as the processed scan data 234.

The creation of the second internal scanning signal 552 is now described.

In the embodiment in which the scanning synchronization signal 232 simply comprises the cleaned up pulses from the position encoder 205, the scanning synchronization signal control block 512 of the second ASIC 222 processes the scanning synchronization signal 232 in a manner very similar to that described with respect to the formation of the first internal scanning signal 452 and the first control signal 214 of first ASIC 212.

Thus, when the scanning synchronization signal 232 arrives at the scanning synchronization signal control block 512 of the second ASIC 222, it is first filtered or “debounced”. The circuitry that performs this filtering is configured to detect a minimum constant signal width following each edge of the scanning synchronization signal 232 to ensure that the input signal is stable. The scanning synchronization signal control block 512 then outputs the second internal scanning signal 552 either at every edge or just at rising or falling edges (generally, at every other edge). This allows scanning synchronization to occur each time the scanning synchronization signal 232 either toggles or pulses, depending on a programmable setting. Since in this embodiment each pulse from the position encoder 205 is embodied in the scanning synchronization signal 232, such toggling or pulsing occurs upon each movement of the automatic document feed, for maximum scanning resolution.

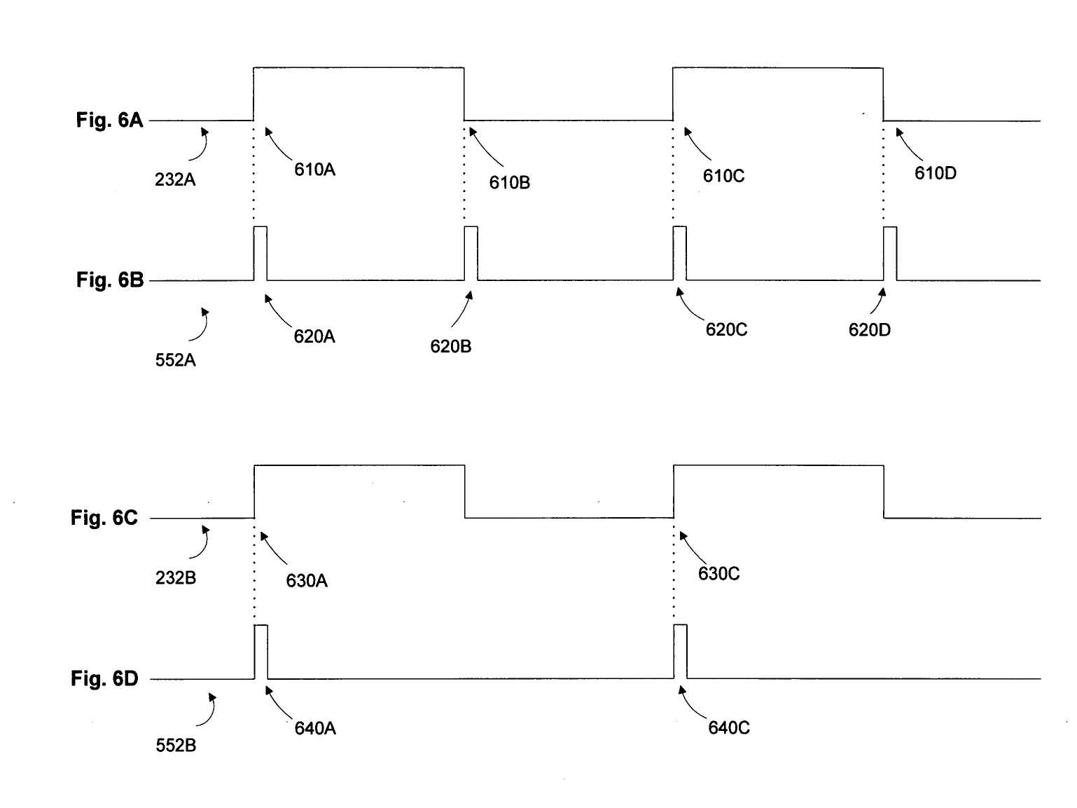

FIG. 6A shows a first exemplary synchronization signal 232A in which the rising edges 610A, 610C as well as the falling edges 610B, 610D are both used to create a second internal scanning signal 552A (see FIG. 6B) having corresponding pulses 620A, 620C, 620B, 620D which are subsequently manifested as a second control signal 224 directed to the second scanning element 220. FIG. 6C shows a second exemplary synchronization signal 232B in which only the rising edges 630A, 630C are used to create a second internal scanning signal 552B (see FIG. 6D) having corresponding pulses 640A, 640C which are subsequently manifested as the second control signal 224 used to control the second scanning element 220. It is understood that one may similarly use the falling edge instead of the rising edge in the embodiment of FIGS. 6C and 6D.

In the embodiment in which the scanning synchronization signal 232 comprises a triggering pulse that is output upon receipt of a predetermined number of pulses from the position encoder 205, the triggering pulse is first cleaned by the scanning synchronization signal control block 512. Then, the rising edge (or, if desired, the falling edge) of the cleaned triggering pulse is used to create the second internal scanning signal 552 and the second control signal 224.

Depending on how the ASICs 212, 222 are configured, in one embodiment, the first internal scanning signal 452 (or the first control signal 214) and the second internal scanning signal 552 (or the second control signal 224) may be synchronized with each other so that scan data is read from the scanning elements 210, 220 at the same time. In other embodiments, one of these signals may be delayed relative to the other. Such a delay can be used to compensate for the positional offset in the corresponding scanning elements 210, 220. More significantly, it may allow for simultaneously receiving scan data corresponding to information present on opposite sides of the original document 202A at the same distance from the leading edge of that document, as the document travels along the path P.

A comparison of the first and second ASICs 212, 222 shows that the functionality of the second ASIC may be a subset of the first ASIC, subject to certain programmable changes. Accordingly, it may be possible to design a single ASIC which may selectively be used to serve either as the first ASIC 212 or as the second ASIC 222. It is understood, however, that portions of the various blocks, and even entire blocks, may need to be disabled, such as by programming, to effect this. Alternatively, it may be possible to design a single ASIC which incorporates the functionality of first and second ASICs 212, 222. Thus the use of two ASICs in the foregoing description is for the purposes of illustration and not limitation.

People skilled in the art of ASIC design for multifunction devices are familiar with the design and operation of such subcomponents as the motor control block 404, the scanner control blocks 408, 508, the USB control block 406, 506, the image processing block 410, 510 and the printer control block 414. The pulse counting, filtering and debouncing provided by the two scanning synchronization signal control blocks 412, 512 are standard operations and so their implementation in an ASIC is also believed to be within the ability of ordinary skill in the art.

Also, while in the foregoing description, a multifunction device was described, it is understood that a pair of ASICs configured as described above, may be used in any device that simultaneously scans both sides of a document, such as a stand-alone scanner, or a copier in addition to a multifunction device.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method of scanning both sides of a document, in a single pass, in a scanner, copier or multifunction device having an automatic document feeder, a motor associated with the automatic document feeder, a first integrated circuit (IC) configured to control a first scanning element for scanning a first side of the document, and a second IC configured to control a second scanning element for scanning a second side of the document, the method comprising:
receiving, at the first IC, information reflective of movement or position of at least one of the motor and the document;
creating, by the first IC, a synchronization signal in response to said information, and supplying the synchronization signal to the second IC; and
obtaining, at the second IC, second scan data from the second scanning element, in response to said synchronization signal.

2. The method according to claim 1, comprising obtaining second scan data from the second scanning element in response to at least one of the rising edge and the falling edge of the synchronization signal.

3. The method according to claim 2, comprising obtaining second scan data from the second scanning element in response to both the rising edge and the falling edge of the synchronization signal.

4. The method according to claim 1, wherein said information is derived from one or more pulses from a position encoder.

5. The method according to claim 4, wherein said synchronization signal comprises a waveform substantially similar to a cleaned up version of said one or more pulses.

6. The method according to claim 4, comprising creating said synchronization signal upon receipt of a predetermined number of pulses from the position encoder.

7. The method according to claim 4, comprising:
forming a first control signal based on at least one of said pulses; and
obtaining, at said first IC, first scan data in response to said first control signal.

8. The method according to claim 7, comprising:
forming a second control signal based on said synchronization signal; and
obtaining, at said second IC, said second scan data in response to said second control signal.

9. The method according to claim 1, comprising:
obtaining, at the first IC, first scan data corresponding to data present on the first side of the document at a point a first distance from a leading edge of the document; and
simultaneously obtaining, at the second IC, second scan data corresponding to data present on the second side of the document at a point a second distance from a leading edge of the document, wherein the first and second distances are identical.

10. A scanner, copier or multifunction device configured to simultaneously scan both sides of a document in a single pass, comprising:
an automatic document feeder for feeding a document;
a first integrated circuit (IC) configured to:
communicate with a motor associated with the automatic document feeder; and
communicate with a first scanning element arranged to scan a first side of the document; and
receive information reflective of movement or position of at least one of said motor and said document; and
a second IC configured to communicate with a second scanning element arranged to scan a second side of the document;
wherein the first IC creates a synchronization signal in response to said information and supplies said synchronization signal to the second IC; and the second IC receives scan data from the second scanning element, in response to said synchronization signal.

11. The scanner, copier or multifunction device according to claim 10, wherein the first IC and the second IC are both application specific integrated circuits (ASICs) comprising at least one CPU and an image processing block.

12. The scanner, copier or multifunction device according to claim 11, wherein the first IC and the second IC both reside on a common printed circuit board.

13. The scanner, copier or multifunction device according to claim 10, wherein the second IC includes Universal Serial Bus (USB) block and processes the scan data received from the second scanning element and provides processed scan data to the first IC via the USB block of the second IC.

14. The scanner, copier or multifunction device according to claim 10, wherein the second IC receives scan data from the second scanning element in response to at least one of the rising edge and the falling edge of the synchronization signal.

15. The scanner, copier or multifunction device according to claim 14, wherein the second IC receives scan data from the second scanning element in response to both the rising edge and the falling edge of the synchronization signal.

16. The scanner, copier or multifunction device according to claim 10, further comprising a position encoder, and wherein said information is derived from one or more pulses from said position encoder.

17. The scanner, copier or multifunction device according to claim 16, wherein said synchronization signal comprises a waveform substantially similar to a cleaned up version of said one or more pulses.

18. The scanner, copier or multifunction device according to claim 16, wherein said synchronization signal is created upon receipt of a predetermined number of pulses from the position encoder.

19. The scanner, copier or multifunction device according to claim 16, wherein:
the first integrated circuit forms a first control signal based on at least one of said pulses; and
the first integrated circuit obtains first scan data from the first scanning element in response to said first control signal.

20. The scanner, copier or multifunction device according to claim 19, wherein:
the second integrated circuit forms a second control signal in response to said synchronization signal, and
the second integrated circuit obtains second scan data from the second scanning element in response to said second control signal.

21. In a method of operating a multifunction device configured to support a dual-sided copying operation in which both sides of an original document are copied in a single pass using an automatic document feeder having a motor associated therewith, the multifunction device having a first application specific integrated circuit (ASIC) configured to obtain first scan data from a first side of said document using a first scanning element and prepare said first scan data for printing, the improvement comprising:
providing a second ASIC configured to process second scan data from a second side of said document using a second scanning element;
creating, by said first ASIC, a synchronization signal based on information reflective of movement or position of at least one of the motor and the original document, and then providing said synchronization signal to the second ASIC;
obtaining, at the second ASIC, second scan data from a second scanning element, in response to said synchronization signal; and
sending, from the second ASIC to the first ASIC, processed second scan data so that the first ASIC may prepare said processed second scan data for printing.

22. The improvement according to claim 21, wherein:
said information comprises one or more pulses from a position encoder;
said synchronization signal comprises a waveform substantially similar to a cleaned up version of said one or more pulses; and
said method further comprises:
forming a first control signal based on at least one of said pulses;
obtaining, at said first IC, said first scan data in response to said first control signal;
forming a second control signal based on said synchronization signal; and
obtaining, at said second IC, said second scan data in response to said second control signal.
